(19) United States
(12) Patent Application Publication
(10) Pub. No.: US 2021/0152777 A1
(43) Pub. Date: May 20, 2021

(54) NETWORK SYSTEM, SERVER, AND INFORMATION PROCESSING METHOD

(71) Applicant: SHARP KABUSHIKI KAISHA, Osaka (JP)

(72) Inventors: MASAKI TAKEUCHI, Tokyo (JP); SHUICHI SATOH, Tokyo (JP); SATOSHI OHTA, Tokyo (JP); HIROSHI OHKUBO, Tokyo (JP); MASANORI OGINO, Tokyo (JP); HIROAKI IWAKURA, Tokyo (JP)

(21) Appl. No.: 17/096,725

(22) Filed: Nov. 12, 2020

(30) Foreign Application Priority Data
Nov. 14, 2019 (JP) 2019-206002

(51) Int. Cl. H04N 7/15

(52) U.S. Cl. CPC H04N 7/15

(57) ABSTRACT

A network system includes: a plurality of terminals configured to hold a chat and a video conference; and a server configured to cause a candidate for a file of a document to be selected on a screen for the chat at one terminal of the plurality of terminals and to launch the video conference with the document ready to be referenced when a first button for starting the video conference is pressed at the one terminal.

### CROSS-REFERENCE TO RELATED APPLICATION

The present application claims priority from Japanese Application JP2019-206002, the content to which is hereby incorporated by reference into this application.

### BACKGROUND OF THE INVENTION

### 1. Field of the Invention

An aspect of the disclosure relates to a technique for exchanging various types of information through a chat utilizing a network.

### 2. Description of the Related Art

Various communication tools utilizing networks are known in the related art. For example, JP 2016-171373 A discloses a service provision device, a communication method, a communication system, and a program.

JP 2016-171373 A provides a first service provision device for providing a first service to a terminal identified by first identification information used to utilize a first service, the first service provision device including an acquisition unit configured to acquire second identification information by inquiring of a management device configured to manage first identification information in association with second identification information used to utilize a second service different from the first service, about the second identification information corresponding to the first identification information, and an inquiry unit configured to inquire of a second service provision device configured to provide the second service, about state information corresponding to the acquired second identification information, for determining whether a terminal or a user identified by the acquired second identification information can communicate on the basis of the second service.

### SUMMARY OF THE INVENTION

An object of an aspect of the disclosure is to provide a technique for switching between a chat and a video conference more smoothly than in the related art.

According to an aspect of the disclosure, a network system is provided that includes: a plurality of terminals configured to hold a chat and a video conference; and a server configured to cause a candidate for a file of a document to be selected on a screen for the chat at one terminal of the plurality of terminals and to launch the video conference with the document ready to be referenced when a first button for starting the video conference is pressed at the one terminal.

As described above, according to an aspect of the disclosure, a technique can be provided for switching between a chat and a video conference more smoothly than in the related art.

### BRIEF DESCRIPTION OF THE DRAWINGS

FIG. 1 is a conceptual diagram illustrating an overall configuration of a network system 1 according to a first embodiment.

FIG. 2 is a first conceptual diagram illustrating functions of the network system 1 according to the first embodiment.

FIG. 3 is a second conceptual diagram illustrating the functions of the network system 1 according to the first embodiment.

FIG. 4 is a conceptual diagram illustrating a first example of a screen of a communication terminal 300 of the network system 1 according to the first embodiment.

FIG. 5 is a conceptual diagram illustrating a second example of a screen of the communication terminal 300 of the network system 1 according to the first embodiment.

FIG. 6 is a conceptual diagram illustrating a third example of a screen of the communication terminal 300 of the network system 1 according to the first embodiment.

FIG. 7 is a conceptual diagram illustrating a fourth example of a screen of the communication terminal 300 of the network system 1 according to the first embodiment.

FIG. 8 is a conceptual diagram illustrating a fifth example of a screen of the communication terminal 300 of the network system 1 according to the first embodiment.

FIG. 9 is a block diagram illustrating a configuration of the communication terminal 300 according to the first embodiment.

FIG. 10 is a block diagram illustrating a configuration of a server 100 according to the first embodiment.

FIG. 11 is a diagram illustrating functions of a chat service provided by the server 100 according to the first embodiment.

FIG. 12 is a block diagram illustrating a configuration of data 121 for the chat service according to the first embodiment.

FIG. 13 is a diagram illustrating functions of a video conference service provided by the server 100 according to the first embodiment.

FIG. 14 is a block diagram illustrating a configuration of data 122 for the video conference service according to the first embodiment.

FIG. 15 is a flowchart illustrating a processing procedure of the server 100 according to the first embodiment.

### DETAILED DESCRIPTION OF THE INVENTION

Embodiments of the disclosure will be described below with reference to the drawings. In the following description, identical components are given identical reference signs. Respective names and functions of the components will also be identical. Thus, detailed descriptions will not be repeated for the components.

### First Embodiment

### Overall Configuration of Network System 1

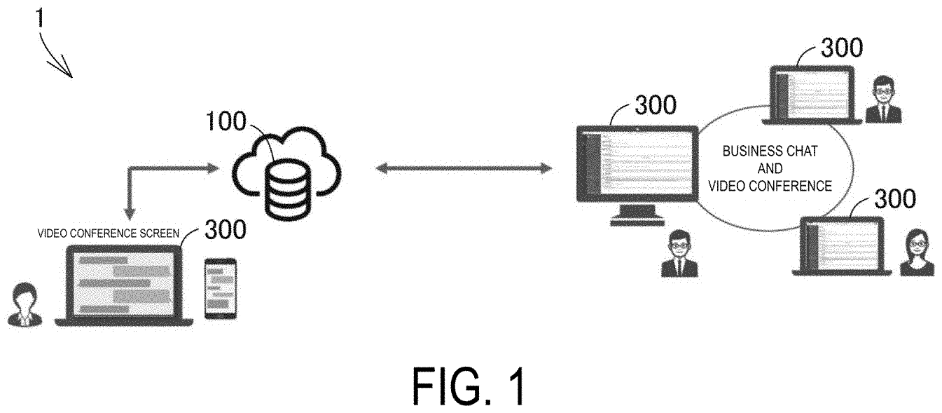

First, with reference to FIG. 1, an overall configuration of a network system 1 according to the present embodiment will be described. The network system 1 according to the present embodiment primarily includes a server 100 configured to provide a chat service and a video conference service, and communication terminals 300, 300 utilized by a plurality of users who utilize the services.

The server 100 is practically configured by a plurality of calculation devices, databases, and other components on a cloud. For example, a concept of the server 100 includes a server that operates a Web site for providing a chat service, a server that operates a Web site for providing a video conference service, and a server configured to switch between the two services and share files between the two services.

The plurality of communication terminals 300, 300 are practically configured by a smart phone, a tablet, a personal computer, a speaker, or the like, and can communicate with the server 100 via the Internet or a carrier network.

### Operational Overview of Network System 1

Now, an operational overview of the network system 1 according to the present embodiment will be described.

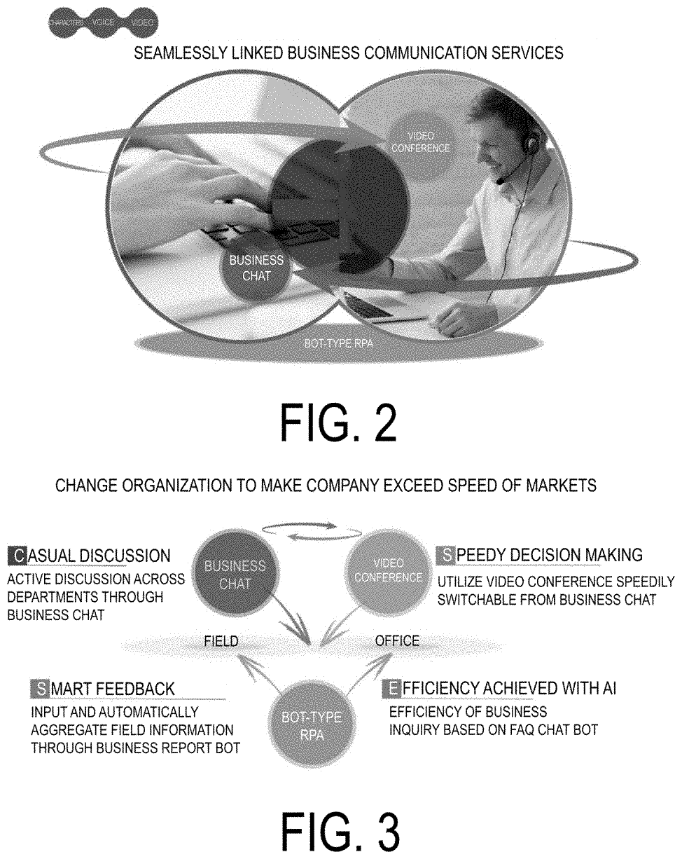

With reference to FIG. 2, the network system 1 according to the present embodiment can switch between a business chat and a video conference by a simple operation. In other words, as illustrated in FIG. 3, the network system 1 according to the present embodiment makes it possible to implement casual discussion through a business chat or speedy decision making through a video conference.

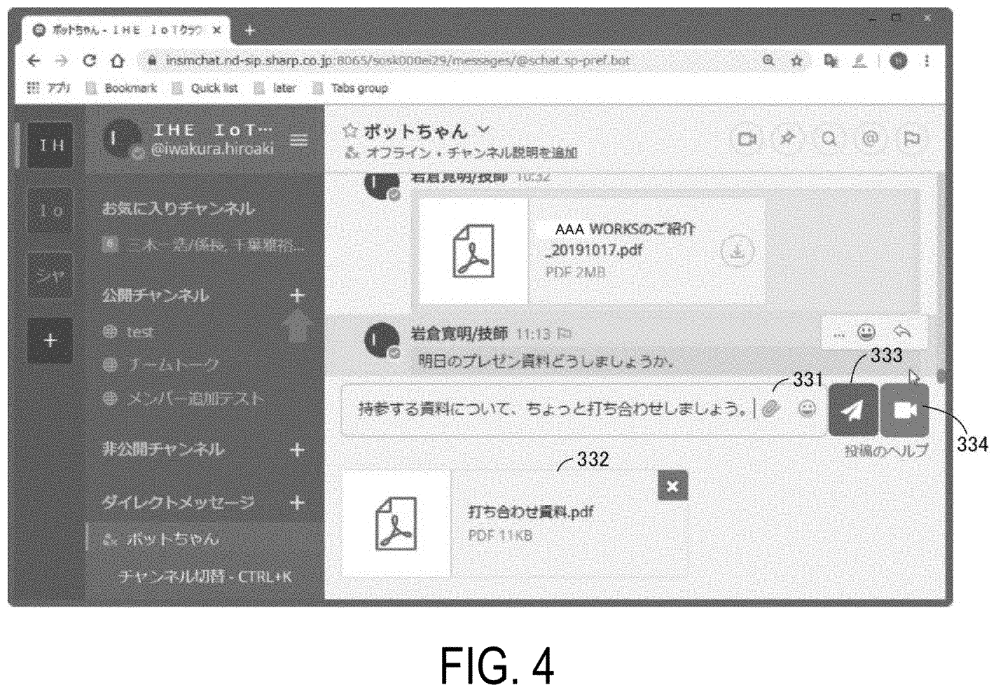

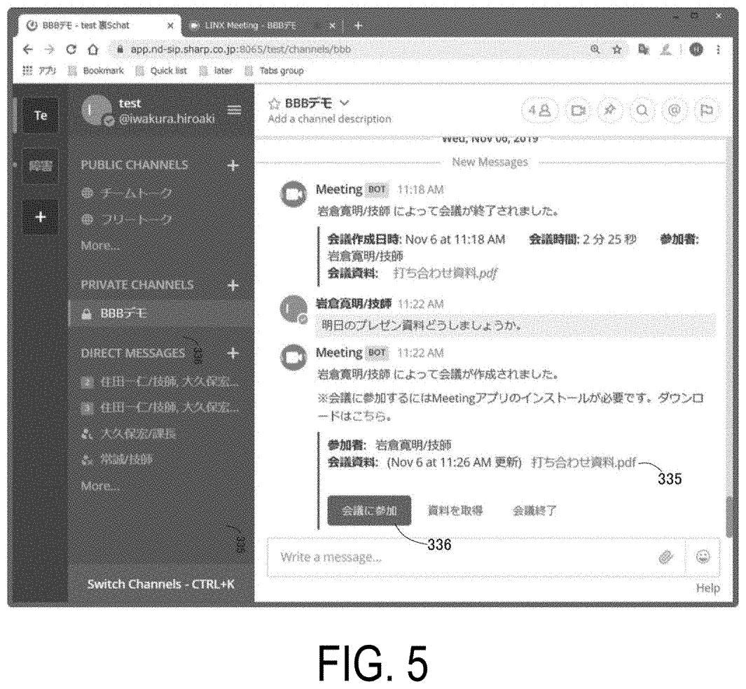

In particular, in the present embodiment, the user can use a simple operation to display and utilize, at a video conference, a document to be presented to a chat. More specifically, the user uses the communication terminal 300 to select a file such as a document used at a conference by pressing a file attachment button 331 on a chat screen as illustrated in FIG. 4. The selected file is presented with an icon 332 as a candidate. Note that, in a case where a plurality of files are selected simultaneously or sequentially, the icons 332 for the selected plurality of files are presented. In this state, when a video conference launch button 334 is pressed, as illustrated in FIG. 5, an attached icon 335 for the one or more files is displayed on the chat, and a new video conference room is launched, where the one or more files are registered in the video conference room so as to be referenced.

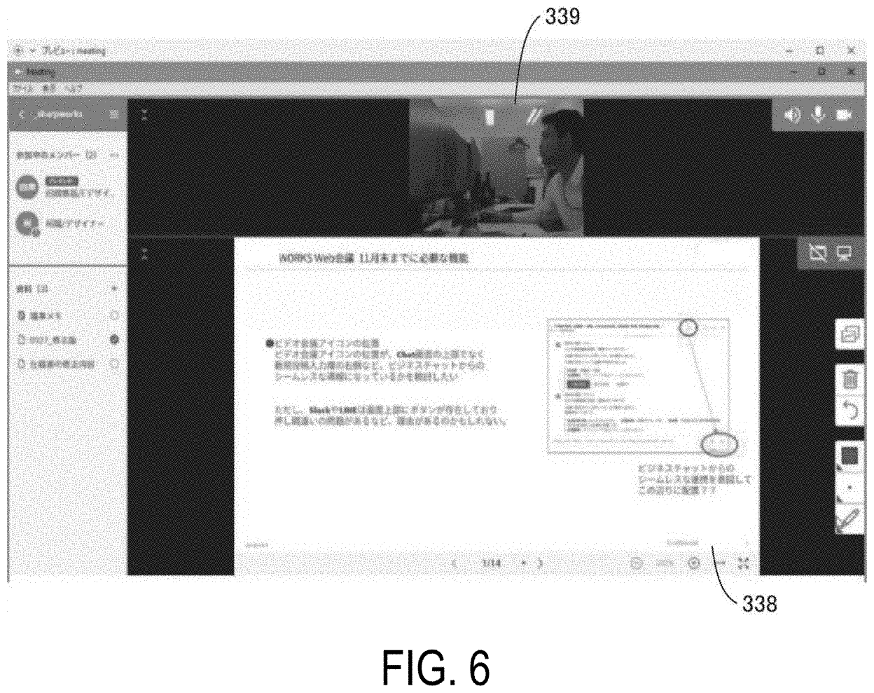

In this state, when the user presses a participate in conference button 336 used to participate in the conference, the screen switches to a video conference screen as illustrated in FIG. 6. On the video conference screen, an image 338 of the contents of the document is displayed, and an image 339 of a discussion partner, an image of the user, and the like are displayed. In other words, in the present embodiment, when a file such as a document is selected and the video conference launch button 334 is pressed, the file is uploaded to the chat, and a new video conference room is launched with the document being displayed.

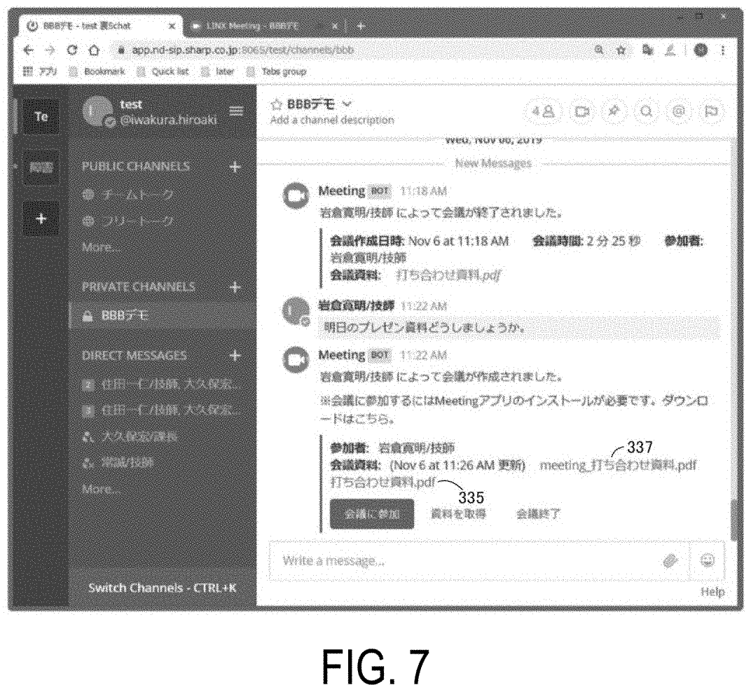

Then, when, the document is edited or new text is written at the video conference, as illustrated in FIG. 7, a message indicating that the user is in a video conference, the icon 335 of the file of the original document and an icon 337 of a file of the latest document are displayed in a section indicating information relating to launching a video conference on the chat. This allows the chat participants to acquire the file of the latest document.

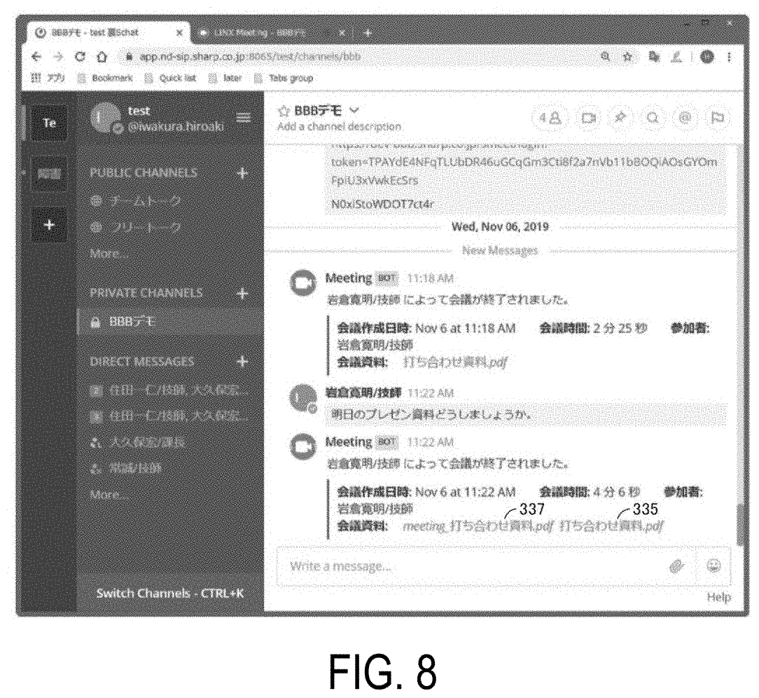

Then, when the video conference is ended, as illustrated in FIG. 8, a message indicating that the video conference has ended, the icon 335 of the file of the original document, and the icon 337 of the file of the latest document are displayed in the section indicating information relating to launching a video conference on the chat. This allows the chat participants to acquire a file of the final document.

Hereinafter, a specific configuration of the network system 1 for achieving such a function will be described in detail.

### Configuration of Communication Terminal

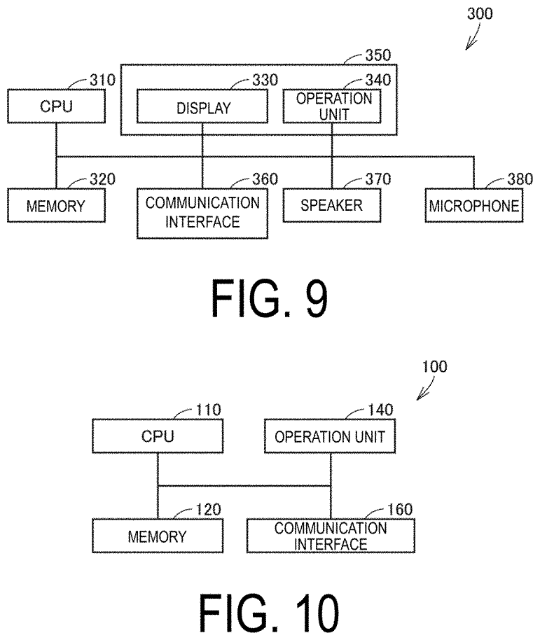

With reference to FIG. 9, an aspect of a configuration of the communication terminal 300 included in the network system 1 will be described.

The communication terminal 300 according to the present embodiment includes a CPU 310, a memory 320, a display 330, an operation unit 340, a communication interface 360, a speaker 370, and a microphone 380 as main components.

The CPU 310 controls each unit of the communication terminal 300 by executing a program stored in the memory 320.

The memory 320 is practically configured by various types of RAM, various types of ROM, and the like. The memory 320 stores application programs for various services, data generated by the CPU 310 executing the programs, data received from the server 100, data input via the operation unit 340, information used to identify the communication terminal 300 and the user of the communication terminal 300, and the like.

The display 330 displays images and text based on the data from the CPU 310. The operation unit 340 includes a pointing device and a switch, and inputs various types of instructions to the CPU 310. Note that the communication terminal 300 may include a touch panel 350 including the display 330 and the operation unit 340.

The communication interface 360 transmits and/or receives data to and/or from other devices such as the server 100 via the Internet, a carrier network, a router, or the like. For example, the CPU 310 exchanges text data and file data for a chat or moving image data and voice data for a video conference with the server 100 via the communication interface 360 in accordance with an application program for a Web browser.

The speaker 370 performs various voice output based on signals from the CPU 310. The CPU 310 may output, to a destination not limited to the display 330, voice of the video conference received from the server 100.

The microphone 380 receives the voice and inputs the voice data to the CPU 310. The CPU 310 receives a voice message of the video conference from the user, via a component not limited to the operation unit 340, and transmits the voice message to the server 100.

### Configuration of Server

Now, an aspect of a configuration of the server 100 included in the network system 1 according to the present embodiment will be described. As illustrated in FIG. 10, the server 100 includes a central processing unit (CPU) 110, a memory 120, an operation unit 140, and a communication interface 160 as main components.

The CPU 110 controls each unit of the server 100 by executing programs stored in the memory 120. For example, the CPU 110 performs various types of processing, which will be described below, by executing programs stored in the memory 120 and referring to various types of data.

The memory 120 may be practically configured by various types of RAM, various types of ROM, and the like. The memory 120 may be embedded in the server 100, may be removably attached to various interfaces of the server 100, or may be a recording medium of another device accessible from the server 100. The memory 120 stores the programs that are executed by the CPU 110, data generated as a result of the CPU 110 executing the programs, input data, other databases used for services relating to the present embodiment, and the like. For example, the memory 120 according to the present embodiment stores data used in various types of services.

The operation unit 140 receives instructions from a service administrator or the like, and inputs the instructions to the CPU 110.

The communication interface 160 transmits data from the CPU 110 to other devices such as the communication terminal 300 via the Internet, a carrier network, a router, or the like. In contrast, the communication interface 160 receives data from other devices such as the communication terminal 300 via the Internet, a carrier network, a router, or the like, and delivers the data to the CPU 110.

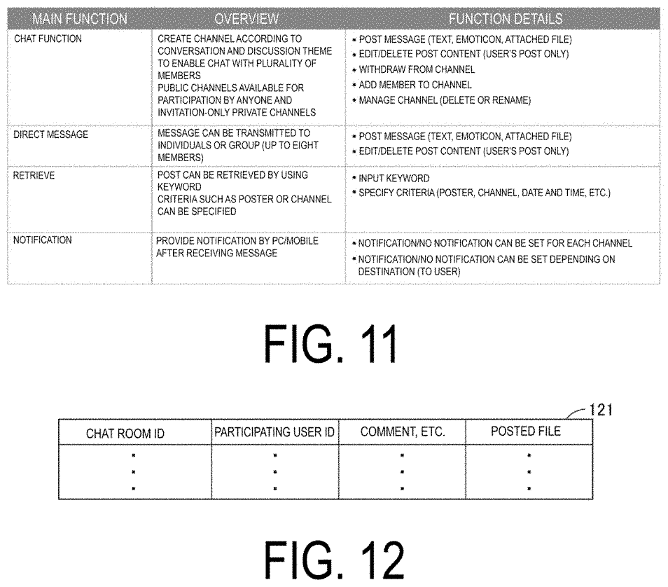

The CPU 110 according to the present embodiment implements functions as illustrated in FIG. 11 via the communication interface 160 in accordance with a program for the chat service in the memory 120. For example, the memory 120 stores data 121 that stores, for each chat room, correspondence relationships between a room ID, IDs of participating members, posted comments, emoticons, and stamps, files of uploaded documents, and the like, as illustrated in FIG. 12.

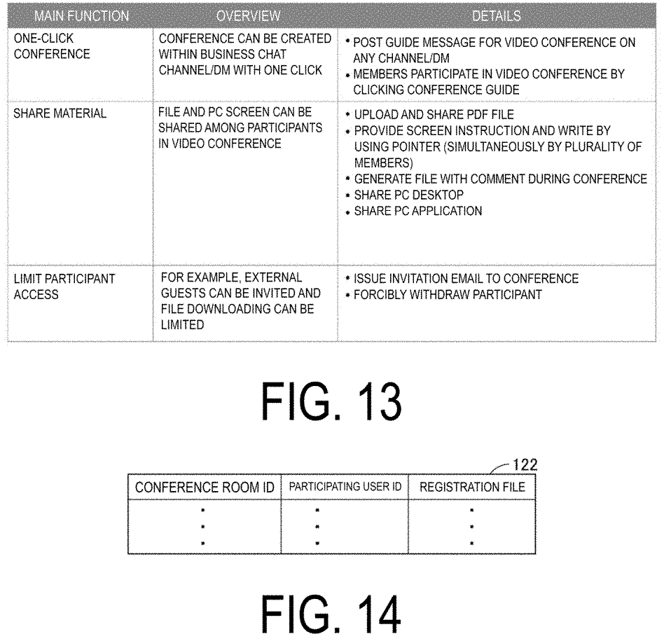

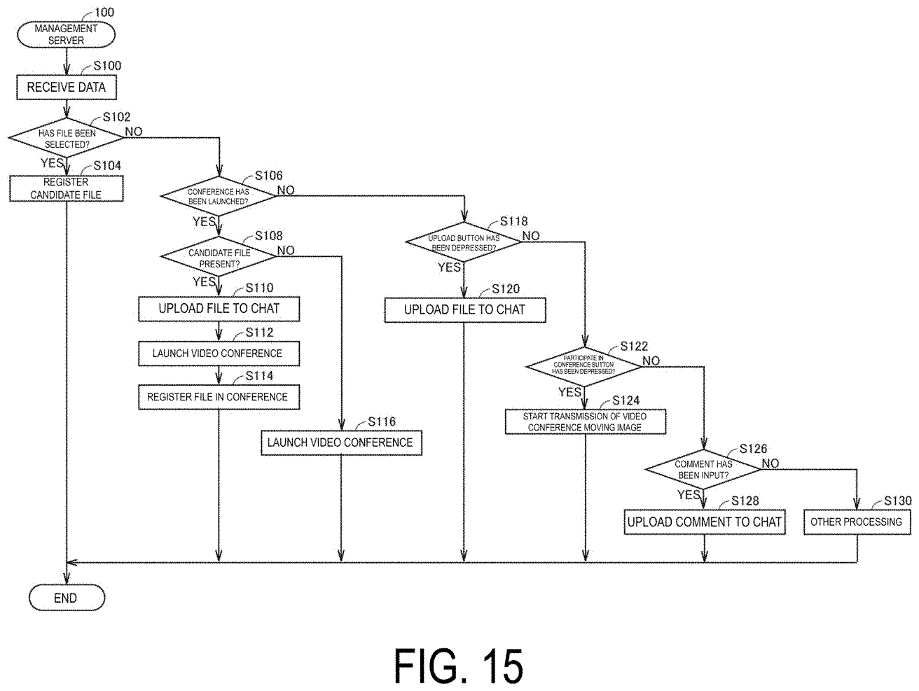

The CPU 110 according to the present embodiment implements functions as illustrated in FIG. 13 via the communication interface 160 in accordance with a program for the video conference service in the memory 120. For example, the memory 120 stores data 122 storing, for each video conference room, correspondence relationships between a room ID, IDs of participating members, files of documents uploaded and referenced at the video conference, and the like, as illustrated in FIG. 14.

### Information Processing by Server

Information processing in the server 100 according to the present embodiment will be described below, the information processing being related to switching between the chat service and the video conference service. Note that, for the purpose of description below, the function of the chat service, the function of the video conference service, and the function of switching between these two functions will be described below as an aspect implemented by a single server 100, but these functions may be implemented by separate devices or may be shared among more devices. As illustrated in FIG. 15, the CPU 110 of the server 100 executes the following processing in accordance with the program in the memory 120.

First, the CPU 110 of the server 100 utilizes the communication interface 160 to receive data from the communication terminal 300 via a Web site, for example (step S100).

The CPU 110 determines whether a file has been selected on the chat screen of the communication terminal 300, as illustrated in FIG. 4 (step S102). In a case where a file has been selected at the communication terminal 300 (YES in step S102), the CPU 110 registers the file as a candidate to be uploaded to the chat (step S104). The CPU 110 waits for the next processing.

In a case where no file has been selected in the processing (NO in step S102), the CPU 110 determines whether the video conference launch button 334 has been pressed at the communication terminal 300 (step S106). In a case where the video conference launch button 334 has been pressed at the communication terminal 300 (YES in step S106), the CPU 110 determines whether any candidate for a file is registered in the communication terminal 300 (step S108).

In a case where a candidate for a file is registered in the communication terminal 300 (YES in step S108), the CPU 110 attaches the file to the chat (step S110). The CPU 110 launches a room for a video conference (step S112). The CPU 110 registers the file in association with the room for the video conference, as illustrated in FIG. 5 (step S114). In other words, the CPU 110 registers the file in the data 122. The CPU 110 waits for the next processing.

In a case where no candidate for a file is registered in the communication terminal 300 (NO in step S108), the CPU 110 launches the room for the video conference (step 3116). The CPU 110 waits for the next processing.

In a case where the video conference launch button 334 has not been pressed at the communication terminal 300 (NO in step S106), the CPU 110 determines whether an upload button 333 has been pressed at the communication terminal 300 (step S118). In a case where the upload button 333 has been pressed at the communication terminal 300 (YES in step S118), the CPU 110 posts the file to the chat (step 3120). The CPU 110 waits for the next processing.

In a case where the upload button 333 has not been pressed at the communication terminal 300 (NO in step S118), the CPU 110 determines whether the participate in conference button 336 has been pressed at the communication terminal 300 (step S122). In a case where the participate in conference button 336 has been pressed at the communication terminal 300 (YES in step S122), the CPU 110 registers the user of the communication terminal 300 as a participating member of the video conference, and starts transmitting the screen of the video conference to the communication terminal 300, as illustrated in FIG. 6 (step S124).

In particular, in the present embodiment, the CPU 110 references the data 122 to cause the communication terminal 300 to display images of the participants while displaying the contents of the file registered in the video conference, via the communication interface 160, as illustrated in FIG. 6.

In a case where the participate in conference button 336 has not been pressed at the communication terminal 300 (NO in step S122), the CPU 110 determines whether a comment has been input at the communication terminal 300 (step S126). In a case where a comment has been input at the communication terminal 300 (YES in step S126), the CPU 110 posts the comment to the chat (step S128). The CPU 110 waits for the next processing.

In a case where no comment has been input at the communication terminal 300 (NO in step S126), the CPU 110 performs other processing (step S130).

### Second Embodiment

Note that, in the embodiment described above, the updated file is uploaded to the section related to launching the video conference in the chat screen. In other words, when a comment is posted to the chat after the video conference is launched, the screen needs to be returned to the section related to launching the video conference in the chat screen to acquire the file. However, each time the file is updated, a new section related to the video conference may be automatically created with the updated file attached to the section, or the section related to launching the video conference may move to the newest position.

### Third Embodiment

In addition to the embodiments described above, it is preferable that a person other than the participants in the chat can be invited to the video conference. For example, the communication terminal 300 can preferably transmit, from the video conference screen in FIG. 6, an invitation email containing a URL for participating in the video conference, to a desired user not participating in the chat.

### Fourth Embodiment

Some or all of the roles of each of the devices of the network system 1 in the above-described embodiments may be performed by other devices. For example, some or all of the roles of each of the server 100 and the communication terminal 300 may be performed by other devices, or some or all of each of the roles of the devices may be divided and performed by a plurality of devices. For example, the server 100 may perform most of the processing, and the communication terminal 300 may achieve the above-described functions by using a normal web browser or the like. In contrast, part or all of the role of the server 100 may be realized by the application program of the communication terminal 300. Specifically, the CPU 310 of the communication terminal 300 may perform a chat, a video conference, switching between the chat and the video conference, exchange of files, and the like based on the corresponding programs in the memory 320.

### Supplement

In the above embodiments, a network system is provided that includes: a plurality of terminals configured to hold a chat and a video conference; and a server configured to cause a candidate for a file of a document to be selected on a screen for the chat at one terminal of the plurality of terminals and to launch the video conference with the document ready to be referenced when a first button for starting the video conference is pressed at the one terminal.

Preferably, the server also posts the file of the document to the chat when the first button is pressed at the one terminal.

Preferably, the screen for the chat of the one of the terminals is also caused to display a second button for posting the file of the document to the chat without starting the video conference.

Preferably, in the screen for the chat on the one terminal, files of a plurality of documents selected are received as candidates.

Preferably, the server posts, to the chat, a file of a document reflecting edition at the video conference.

Preferably, when the video conference is ended, the server posts, to the chat, the file of the document edited at the video conference.

Preferably, when the first button is pressed at the one terminal, the server posts, to the chat, information indicating that the video conference has been launched, and posts the file of the edited document to an area of the information.

In the above embodiments, a server is provided that includes: a communication interface configured to communicate with a plurality of terminals; and a processor configured to utilize the communication interface to cause a candidate for a file of a document to be selected on a screen for a chat at one terminal of the plurality of terminals and to launch a video conference with the document ready to be referenced when a first button for starting the video conference is pressed at the one terminal.

In the above embodiments, an information processing method is provided that includes: selecting a candidate for a file of a document on a screen for a chat at one terminal of a plurality of terminals; and launching, by a server, a video conference with the document ready to be referenced when a first button for starting the video conference is pressed at the one terminal.

The embodiments disclosed here are to be understood as being in all ways exemplary and in no ways limiting. The scope of the disclosure is defined not by the foregoing descriptions but by the appended claims, and is intended to include all changes equivalent in meaning and scope to the claims.

What is claimed is:

1. A network system comprising:
a plurality of terminals configured to hold a chat and a video conference; and
a server configured to cause a candidate for a file of a document to be selected on a screen for the chat at one terminal of the plurality of terminals and to launch the video conference with the document ready to be referenced when a first button for starting the video conference is pressed at the one terminal.

2. The network system according to claim 1,
wherein the server also posts the file of the document to the chat when the first button is pressed at the one terminal.

3. The network system according to claim 1,
wherein the screen for the chat of the one terminal is also caused to display a second button for posting the file of the document to the chat without starting the video conference.

4. The network system according to claim 1,
wherein, in the screen for the chat on the one terminal, files of a plurality of documents selected are received as candidates.

5. The network system according to claim 1,
wherein the server posts, to the chat, a file of a document reflecting editing at the video conference.

6. The network system according to claim 1,
wherein, when the video conference is ended, the server posts, to the chat, the file of the document edited at the video conference.

7. The network system according to claim 5,
wherein, when the first button is pressed at the one terminal, the server posts, to the chat, information indicating that the video conference has been launched, and posts the file of the edited document to an area of the information.

8. A server comprising:
a communication interface configured to communicate with a plurality of terminals; and
a processor configured to utilize the communication interface to cause a candidate for a file of a document to be selected on a screen for a chat at one terminal of the plurality of terminals and to launch a video conference with the document ready to be referenced when a first button for starting the video conference is pressed at the one terminal.

9. An information processing method comprising:
selecting a candidate for a file of a document on a screen for a chat at one terminal of a plurality of terminals; and
launching, by using a server, a video conference with the document ready to be referenced when a first button for starting the video conference is pressed at the one terminal.
